(19) United States
(12) Patent Application Publication
(10) Pub. No.: US 2020/0202609 A1
(43) Pub. Date: Jun. 25, 2020

(54) INFORMATION PROCESSOR, CONTROL METHOD, AND PROGRAM

(71) Applicant: SONY INTERACTIVE ENTERTAINMENT INC., TOKYO (JP)

(72) Inventors: Tatsuki AMIMOTO, TOKYO (JP); Akira NISHIYAMA, TOKYO (JP)

(21) Appl. No.: 16/620,101

(22) PCT Filed: Jun. 15, 2018
(86) PCT No.: PCT/JP2018/022980

§ 371 Date: Dec. 6, 2019

(30) Foreign Application Priority Data
Jun. 22, 2017 (JP) 2017-122407

(51) Int. Cl. G06T 15/08; G06T 7/00; G06T 7/73

(52) U.S. Cl. CPC G06T 15/08; G06T 2207/30008; G06T 7/74; G06T 7/0012

(57) ABSTRACT

An information processor acquires information regarding a position and exterior appearance of a target object in a real space, places multiple virtual volume elements in a virtual space at positions corresponding to at least along the exterior appearance of the target object in the real space determined by the acquirer and generates virtual space information representing the target object as a cluster of the virtual volume elements. The information processor detects time variation information of the virtual space information representing shift of at least a portion of the virtual volume elements and estimates positions of the virtual volume elements after a predetermined time duration based on the detected time variation information.

### TECHNICAL FIELD

The present invention relates to an information processor, a control method, and a program.

### BACKGROUND ART

In games using technologies having relatively high information processing loads, such as virtual reality (VR) technology, information to be presented in the future is acquired through prediction so as to hide delay in response due to slow processing. Game screen drawing processes are performed on the basis of the predicted information.

### SUMMARY

### Technical Problem

In the case where a technique is used for acquiring information on a real space with a depth sensor or the like and displaying the acquired information in a virtual space, in general, the rate of information acquisition by the depth sensor is low in comparison with the frame rate of drawing. Thus, there may be a delay in the reflection of the state of the real space to the virtual space, reducing the vividness.

An object of the present invention, which has been conceived in light of the circumstances described above, is to provide an information processor, a control method, and a program that can perform an information presentation process without reducing vividness.

### Solution to Problem

An information processor according to the present invention, which has been conceived to solve the problem of the related art examples, includes an acquirer that acquires information regarding a position and exterior appearance of a target object in a real space; a virtual-space information generator that places multiple virtual volume elements in a virtual space at positions corresponding to at least along the exterior appearance of the target object in the real space determined by the acquirer and generates virtual space information representing the target object as a cluster of the virtual volume elements; a storer that stores the generated virtual space information; a detector that refers to the stored information and detects time variation information of the virtual space information representing shift of at least a portion of the virtual volume elements; and an estimator that performs estimation of positions of the virtual volume elements after a predetermined time duration based on the detected time variation information. The virtual-space information generator generates and outputs virtual space information after a predetermined time duration based on a result of the estimation.

### Advantageous Effect of Invention

According to the present invention, an information presentation process can be performed without reducing vividness.

### BRIEF DESCRIPTION OF DRAWINGS

FIG. 1 is a block diagram illustrating an example configuration of an information processor according to an embodiment of the present invention.

FIG. 2 is a block diagram illustrating an example display connected to an information processor according to an embodiment of the present invention.

FIG. 3 is a functional block diagram illustrating an example information processor according to an embodiment of the present invention.

FIG. 4 is a flow chart illustrating an example operation of an information processor according to an embodiment of the present invention.

FIG. 5 illustrates an example content of processing by an information processor according to an embodiment of the present invention.

FIG. 6 illustrates example drawing timing of an information processor according to an embodiment of the present invention.

FIG. 7 illustrates an example process by an information processor according to an embodiment of the present invention.

### DESCRIPTION OF EMBODIMENT

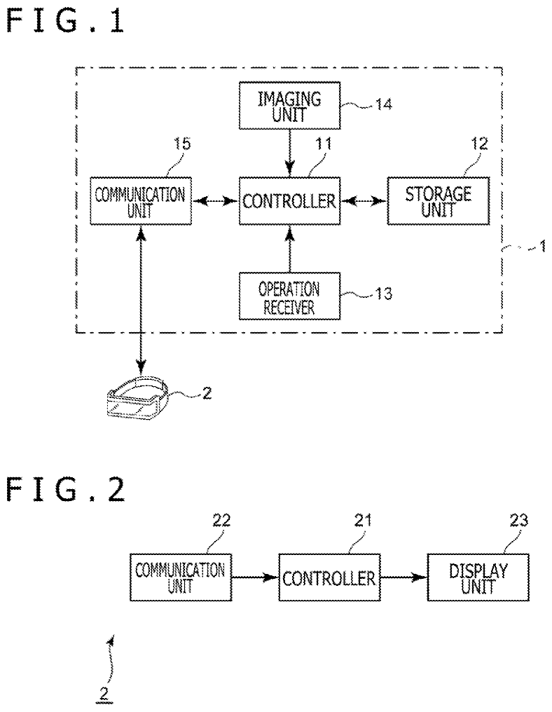

An embodiment of the present invention will now be described with reference to the drawings. An information processor 1 according to an embodiment of the present invention is, for example, a video game console, and includes a controller 11, a storage unit 12, an operation receiver 13, an imaging unit 14, and a communication unit 15, as illustrated in FIG. 1. The information processor 1 is communicably connected with a display 2, such as a head mount display (HMD) worn on the head of a user.

An example display 2 according to the present embodiment to be worn on the head of a user is a display device used while being worn on the head of the user, and includes a controller 21, a communication unit 22, and display unit 23, as illustrated in FIG. 2. In this example, the controller 21 of the display 2 is a program-controlled device, such as a microcomputer. The controller 21 operates in accordance with programs stored in a memory (not illustrated), such as a built-in storage unit, and displays video images corresponding to the information received from the information processor 1 via the communication unit 22, to allow viewing of the video images by the user.

The communication unit 22 is communicably connected with the information processor 1 via wire or wireless connection. The communication unit 22 outputs the information sent from the information processor 1 to the display 2, to the controller 21.

The display unit 23 displays video images corresponding to the left and right eyes of the user. The display unit 23 includes a display element, such as an organic electroluminescence (EL) display panel or a liquid crystal display panel. The display element displays video images in accordance with instructions from the controller 21. The display element may be a single display element that displays an image for the left eye and an image for the right eye side by side or may be two display elements that respectively display an image for the left eye and an image for right eye. The display 2 according to the present embodiment is a non-see-through display that does not allow the user to view the surrounding environment. However, the display 2 may not necessarily be a non-see-through display and alternatively be a see-through display.

The controller 11 of the information processor 1 is a program-controlled device, such as a central processing unit (CPU), and executes the programs stored in the storage unit 12. In the present embodiment, the controller 11 performs a process including acquiring information regarding a position and exterior appearance of a target object in a real space by the imaging unit 14, and placing multiple virtual volume elements in a virtual space at positions corresponding to at least the exterior appearance of the target object in the real space, to generate virtual space information on a virtual space representing the target object with a cluster of the virtual volume elements. This process is performed through a well-known process of, for example, representing a target object by placing multiple virtual volume elements, known as voxels, or representing a target object by placing a point group, such as a point cloud (or point group data, which is hereinafter simply referred to as “point group”) at a position corresponding to the surface of the target object.

The controller 11 detects time variation information on time variation in the virtual space information representing shift in at least a portion of the virtual volume elements, and estimates the positions of the virtual volume elements after a predetermined time duration on the basis of the detected time variation information. The controller 11 then performs a process to generate virtual space information on the virtual space after the predetermined time duration on the basis of the result of the estimation. The controller 11 renders the point group in the field of view of a virtual camera placed at a predetermined position in the virtual space to generate image data, and outputs the generated image data to the display 2 of the user via the communication unit 15. Details of the operation of the controller 11 will be described below.

The storage unit 12 is a memory device, a disc device, or the like, such as a random access memory (RAM), and stores programs to be executed by the controller 11. The storage unit 12 also operates as a work memory of the controller 11 and stores data used by the controller 11 during execution of the programs. The program may be provided on a computer-readable, non-transitory recording medium and stored in the storage unit 12.

The operation receiver 13 receives an instruction operation by the user from an operation device (not illustrated) via wire or wireless connection. The operation device is, for example, a controller of a video game console or the like. The operation receiver 13 outputs, to the controller 11, information representing the content of the instruction operation performed on the operation device by the user. Note that, in the present embodiment, the user is not necessarily required to operate the operation device.

The imaging unit 14 includes an optical camera, a depth sensor, etc. The imaging unit 14 repeatedly acquires image data of images captured within a predetermined field of view in front of the user (forward of the head of the user), and repeatedly acquires distance information on the distance to a target object (another user, a piece of furniture in the room in which the user is present, or the like) in a real space corresponding to the respective pixels in the image data of the predetermined field of view, and then outputs the acquired distance information to the controller 11.

The communication unit 15 is communicably connected with the display 2 of the user via wire or wireless connection. The communication unit 15 receives the image data output from the display 2 and sends the received image data to the controller 11. The communication unit 15 receives information including the image data to be sent from the controller 11 to the display 2 and outputs the received information to the display 2. Furthermore, the communication unit 15 may include a network interface and may transmit and receive various items of data from external server computers and other information processors via a network.

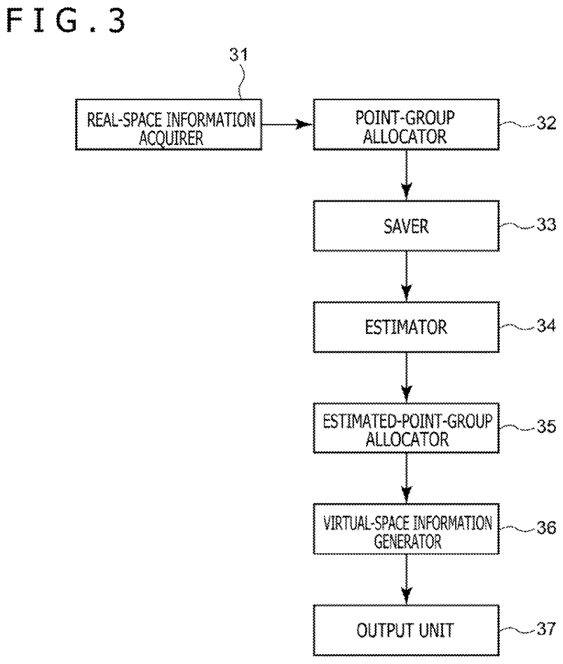

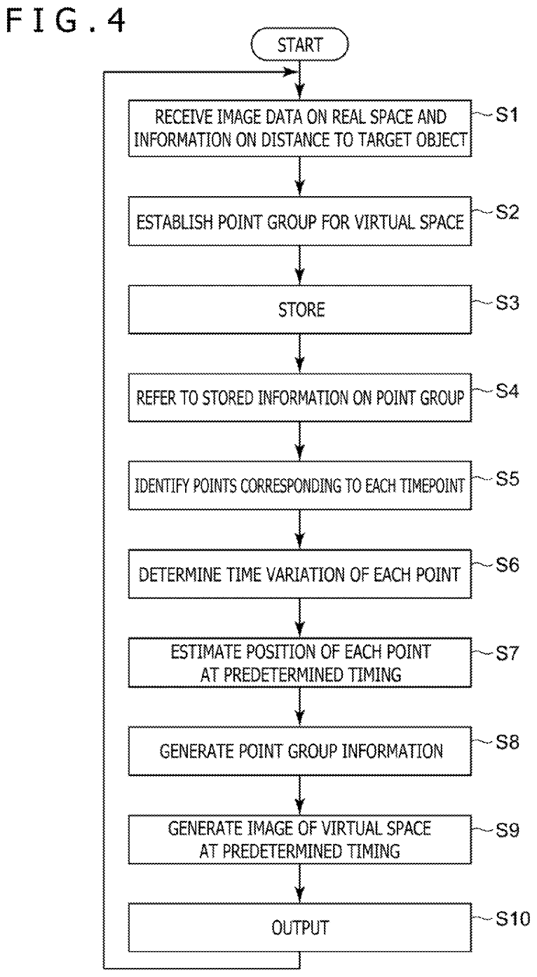

The operation of the controller 11 according to the present embodiment will now be described. In an example of the present embodiment, the controller 11 includes the functions of a real-space information acquirer 31, a point-group allocator 32, a saver 33, an estimator 34, an estimated-point-group allocator 35, a virtual-space information generator 36, and an output unit 37, as illustrated in FIG. 3.

The real-space information acquirer 31 receives, from the imaging unit 14, the captured image data and distance information on the distance to a target object in a real space captured as pixels in the image data. In this way, the real-space information acquirer 31 acquires the position of the target object in the real space and information regarding the exterior appearance (color information). Note that, in an example of the present embodiment, the position, etc., of the target object is represented, for example, by an XYZ Cartesian coordinate system, where the origin is the imaging unit 14, the Z axis is the direction of the field of view of the imaging unit 14, the Y axis is the vertical direction (gravity direction) of the image data captured by the imaging unit 14, and the X axis is an axis orthogonal to the Z and Y axes.

The point-group allocator 32 determines the colors and the positions of points (virtual volume elements) in a point group in a virtual space representing the target object in the real space on the basis of the information acquired by the real-space information acquirer 31. Since the method of establishing such a point group is well known, a detailed description of the method will be omitted here.

The saver 33 stores, in the storage unit 12, the positions and the color information of the respective points in the point group established by the point-group allocator 32. In the present embodiment, the saver 33 acquires date and time information indicating the date and time of the time point at which the point-group allocator 32 establishes the point group, from a clock (calendar integrated circuit (IC) or the like) (not illustrated), and stores point group information in the storage unit 12 in correlation with the acquired date and time information. Note that, at this time, the saver 33 may also store at least a portion of the information acquired by the real-space information acquirer 31 (for example, the captured image data, etc.), which is the source of the point group information.

The estimator 34 detects time variation information on virtual space information representing shift of at least a portion of the virtual volume elements (in this example, the virtual volume elements are the respective points in the point group, and are, hereinafter, referred to as “points” when the virtual volume elements are represented as a point group). In specific, the time variation information is detected as follows. That is, the estimator 34 refers to N sets of information on the point group (information on the color and position of the respective points in the point group, hereinafter referred to as point group information) in a virtual space, that has been saved in the past by the saver 33 at N time points (where N is a positive integer equal to or larger than 2, which in this case is, for example, N=2 (indicating two point groups, a previous point group and a current point group)). The estimator 34 identifies points corresponding to the referred points in the point group. That is, the estimator 34 identifies points in the current point group corresponding to points in the previous point group (establishes the same identification information for points corresponding each other at the respective time points). The estimator 34 then determines the displacement between the corresponding points in the point groups of the respective time points. The displacement is represented using the coordinate system for the virtual space, for example, a Cartesian coordinate system (ξ, η, ζ).

For example, the estimator 34 presumes that the imaging unit 14 has not shifted in position. The estimator 34 refers to the N sets of point group information from the past and identifies points corresponding to each other between the referred point groups of the respective sets of point group information, through a procedure of estimating the displacement between corresponding points among the point groups using the result of comparison for detecting corresponding portion by comparing predetermined characteristic quantities in the image data stored together with the referred point groups, or a process, such as an optical flow.

The estimator 34 determines time variation information on the identified points. The time variation information may include, for example, displacement between identified points (difference equivalent to a differential of the coordinates of each point in the virtual space), the difference values of the displacement (the difference equivalent to a second order differential of the coordinates of the virtual space), the difference of the difference values (the difference equivalent to a third order differential of the coordinates of the virtual space), and so on.

The estimator 34 estimates the future positions of the points or virtual volume elements in the point group in the virtual space at a predetermined time after the time point of calculation, on the basis of the determined time variation information. This estimation may be achieved through extrapolation based on the displacement, the differences, etc., of the respective points. In specific, the estimation may be achieved through numerical integration of the displacement, the differences, etc., of the respective points. The operation of the estimator 34 will be described in more detail below through various modifications.

The estimated-point-group allocator 35 generates point group information on a point group in which the points placed at the future positions in the virtual space on the basis of the result of the estimation by the estimator 34. The virtual-space information generator 36 generates and outputs virtual space information including the point group placed by the estimated-point-group allocator 35.

The output unit 37 renders the point group generated by the virtual-space information generator 36 within the point of view of a virtual camera placed at a predetermined position (such as at the position of the eyes of the user) in the virtual space, to generate image data, and outputs the generated image data to the display 2 of the user via the communication unit 15.

### <Operation>

The present embodiment basically includes the above-described configuration and operates as described in the following. That is, as illustrated in FIG. 4, the information processor 1 according to the present embodiment receives image data captured by the imaging unit 14 and distance information on the distance to a target object in a real space captured as pixels in the image data (S1), and determines the colors and the positions of the respective points in a point group in a virtual space representing the target object in the real space, on the basis of the acquired information (S2). The information processor 1 stores, in the storage unit 12, position and color information on the positions and the colors of the respective points in the point group established here (S3).

At this time, the information processor 1 acquires date and time information indicating the date and time of the time point at which the point group was established in step S2 from a calendar IC or the like (not illustrated), and stores the point group information in the storage unit 12 in correlation with the acquired date and time information. The captured image data that is the source of the point group information determined in step S2 is also stored.

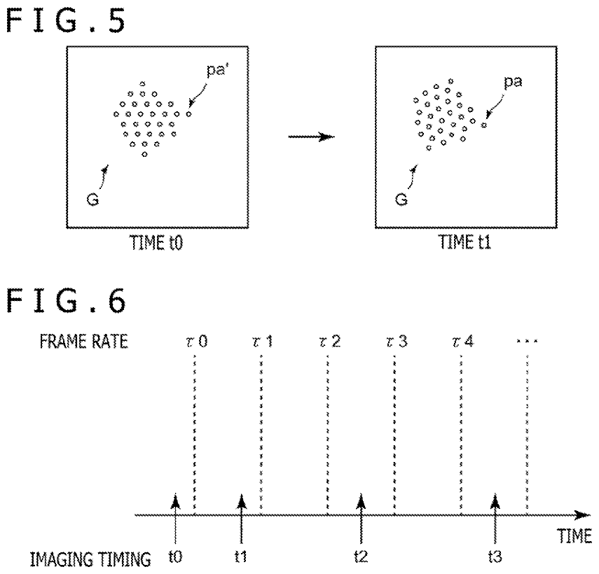

The information processor 1 retrieves and refers to the point group information on the point groups established during step S2 executed N times in the past and saved in step S3 (S4), and identifies points corresponding to each other between the point groups (S5). In specific, as illustrated in FIG. 5, points p included in one of the point groups G representing a target object at time t1 are each selected in sequence to be a target point; a point in the point group at a time t0 (t0<t1) in the past corresponding to each selected target point is specified; and a common identifier is assigned to each selected target point and each corresponding specified point.

The information processor 1 determines time variation information on the identified points (S6). In specific, time variation information AP of a point pa is obtained by determining the difference between the coordinates of a point pa′ at time t0 and the point pa at time t1, both of which are assigned with the same identifier in step S5, and dividing the difference by the time difference (t1−t0). This procedure is performed on each point in the point group at time t1.

The information processor 1 estimates the future positions of the points in the point group in the virtual space at time (t1+Δt) after a predetermined time duration Δt from the time of calculation (time t1), on the basis of the time variation information determined in step S6 (S7). In specific, the respective points in the point group at time t1 are each selected in sequence to be a target point, and the coordinates of a selected target point pN at time (t1+Δt) after the predetermined time duration Δt from the time of calculation (time t1) are estimated to be P+ΔP×Δt by using the coordinates P(ξN, ηN, ζN) of the selected target point pN and the time variation information ΔP determined for the target point pN in step S6. Note that, a target point pN for which time variation information is not determined in step S6 (a point that appears at time t1 and has no corresponding point at time t0) may be estimated to not shift after time t1. Note that steps S5 to S7 in this example operation are mere examples, and other examples will be described in the modifications below.

The information processor 1 generates point group information on a point group in which points are placed at future positions in the virtual space after a predetermined time duration, on the basis of the result of the estimation of step S7 (S8). The information processor 1 then generates on virtual space information on the virtual space including the point group, renders the point group in the field of view of a virtual camera placed at a predetermined position (such as at the position of the eyes of the user) in the virtual space to generate image data (S9), and outputs the generated image data to the display 2 of the user via the communication unit 15 (S10). The information processor 1 then returns the process to step S1. The display 2 presents the rendered image data sent from the information processor 1 to the user.

Note that the information processor 1 may execute the steps S1 to S3 and steps S4 to S10 in parallel, and repeat the execution.

According to this example of the present embodiment, the point group information on a point group at the time of display (rendering) is estimated and generated, regardless of the timing of image capturing. Thus, in general, as illustrated in FIG. 6, even when the timings t0, t1, t2, . . . of the actual image capturing differ from the timings τ0, τ1, τ2, . . . at which rendering is to be performed (timings determined by the frame rate, which is, for example, every 1/30 seconds for a time rate of 30 fps), an image can be provided based on the point group information on the point groups at the timings τ0, τ1, τ2, . . . at which rendering is to be performed.

That is, in the present embodiment, for example, the above-described step S7 estimates the point group information after a time duration of Δt1=T1−t1 and the point group information after a time duration of Δt2=T2−t1 from time t1 (where τ0<τ1<τ1<τ2<τ2), based on the point group information at time t1 and the point group information at time t0 (estimates point group information on point groups at times matching predetermined future timings of drawing); and step S8 generates point group information on point groups at times τ1 and τ2. In this way, images corresponding to drawing timings between times t1 and t2 can be presented to the user, as illustrated in FIG. 6. Thus, even if the image capturing timing is, for example, 15.1 fps and slightly out of sync with the frame rate, images are generated at timings in accordance with the frame rate. Furthermore, drawing can be performed at a high frame rate relative to the image capturing timing.

### <Estimation Based on Points or Voxels>

Some example processes of estimation of shift of virtual volume elements by the controller 11 of the information processor 1 will now be described. The controller 11 may perform estimation with reference to the virtual volume elements. Specifically, in this example, the controller 11 refers to N sets of point group information stored in the storage unit 12 in the past (where N is a positive integer equal to or larger than 2, e.g., N=2 (indicating two point groups, a previous point group and a current point group)), identifies points corresponding to each other between the referred point groups, and determines the displacement between the corresponding points (represented in the coordinate system of the virtual space, for example, a Cartesian coordinate system (ξ, η, ζ)).

The controller 11 then refers to the N sets of the point group information and identifies the corresponding points in referred the point groups of the respective N sets of information, while executing an optical flow process to determine the displacement between corresponding points.

Note that, although an example involving point groups has been described here, the same applies to voxels in that the controller 11 refers to N sets of voxel information on the positions, colors, etc., of the voxels stored in the storage unit 12 (where N is a positive integer equal to or larger than 2, e.g., N=2 (indicating two sets of voxels, a previous set of voxels and a current set of voxels)), identifies voxels corresponding to each other at the respective times in the referred voxel information, determines the displacement of the respective corresponding voxels (represented in the coordinate system of the virtual space, for example, a Cartesian coordinate system (ξ, η, ζ)), and determines the displacement between corresponding voxels in the N sets of voxels at the respective times through an optical flow process or the like.

In the optical flow process, even if deformation is restricted such as in a vertebrate, e.g., a human being (the movable range of various parts, such as arms, of a vertebrate body including a human body is restricted by joints and bones), points are presumed to shift freely regardless of the restriction in some cases. Thus, to determine the displacement of virtual volume elements through processes such as optical flow, virtual volume elements shifted in the same direction may be grouped together (classified by k-approximation or the like), and virtual volume elements having displacements different by dispersion σ from the average displacement within the group may be filtered as noise.

The controller 11 estimates the positions of the virtual volume elements in the virtual space at a predetermined time duration after the time of calculation, on the basis of the time variation information determined in this way. The estimation may be performed through numerical integration based on the displacements of the respective virtual volume elements and their differences, etc.

### <Estimation Based on Model>

In the case where the virtual volume elements represent a target that can be estimated using a bone model, such as the human body, the controller 11 of the information processor 1 may identify each virtual volume element as belonging to a certain bone of the target vertebrate (in the example described below, the target is a human body), and estimate the displacement of the virtual volume elements on the basis of the bone model.

Specifically, in an example of the present embodiment, the controller 11 of the information processor 1 groups together virtual volume elements shifted in the same direction. Such grouping process is performed through schemes such as independent component analysis (ICA), principal component analysis (PCA), k-approximation, and the like. Parts of the human body (the trunk, the upper limbs, the lower limbs, the upper arms, the lower arms, and the head) each approximates a cylinder. Thus, a process of recognizing a cylindrical portion may be performed in combination. A process of recognizing areas having a relatively high density of virtual volume elements may also be combined with the grouping process.

The controller 11 specifies the group having the maximum number of virtual volume elements (hereinafter referred to as maximum group) among the groups of virtual volume elements presumed to correspond to parts of the human body. The controller 11 presumes that the maximum group of virtual volume elements corresponds to the trunk of the human body. The controller 11 then determines the groups of virtual volume elements adjacent to the trunk to correspond to the upper limbs and the groups remote from the trunk to represent lower limbs (a pair of upper limbs and a pair of lower limbs are detected in the left-right direction (X-axis direction)), among the groups of virtual volume elements disposed along the gravity direction (lower side in the Y-axis direction) in the virtual space. The controller 11 further determines the group having the most virtual volume elements among the groups aligned with the center of the trunk in the direction opposite to the gravity direction (upward in the Y-axis direction) to correspond to the head. The controller further determines, among the other groups of virtual volume elements, the groups of virtual volume elements having ends adjacent to upper side of the trunk to correspond to the upper arms, and the groups having ends adjacent the other ends of the upper arms to correspond to the lower arms. The controller 11 typically detects two of each of the upper arms and lower arms.

The controller 11 adds unique identification information (label) to the identified groups of virtual volume elements (labeling process), the groups respectively corresponding to the trunk, the lower limb on the left side of the X-axis (corresponding to the right lower limb), the upper limb on the left side of the X-axis (corresponding to the right upper limb), the lower limb on the right side of the X-axis (corresponding to the left lower limb), the upper limb on the right side of the X-axis (corresponding to the left upper limb), the head, the upper arm on the left side of the X-axis (corresponding to the right upper arm), the lower arm on the left side of the X-axis (corresponding to the right lower arm), the upper arm on the right side of the X-axis (corresponding to the left upper arm), and the lower arm on the right side of the X-axis (corresponding to the left lower arm).

The controller 11 determines a cylinder circumscribing the virtual volume elements belonging to each of the identified groups, the groups respectively corresponding to the trunk, the lower limb on the left side of the X-axis (corresponding to the right lower limb), the upper limb on the left side of the X-axis (corresponding to the right upper limb), the lower limb on the right side of the X-axis (corresponding to the left lower limb), the upper limb on the right side of the X-axis (corresponding to the left upper limb), the head, the upper arm on the left side of the X-axis (corresponding to the right upper arm), the lower arm on the left side of the X-axis (corresponding to the right lower arm), the upper arm on the right side of the X-axis (corresponding to the left upper arm), and the lower arm on the right side of the X-axis (corresponding to the left lower arm). The rotational symmetry axis of the circumscribing cylinder (a line segment having end points at the centers of the respective discoid faces of the cylinder) is defined as a bone. Note that the circumscribing cylinder is determined through schemes such as a method of maximum likelihood estimation of the circumscribing cylinder corresponding to the virtual volume elements through a non-linear optimization, such as the Levenberg-Marquardt method.

The controller 11 adds joints corresponding to the bones to the model of the human body. For example, a joint is added between the head and the trunk as the neck joint. Since the method of adding such join is well known through a process using a bone model, such as the human body, a detailed description of the method will be omitted. Note that a group that does not have an adjacent cylindrical virtual volume elements group (i.e., a joint cannot be added) may be processed as a point group that does not correspond to a human body (i.e., a bone model cannot be used). For such a point group, the controller 11 performs estimation with reference to the virtual volume elements (points or voxels), as described above.

The controller 11 refers to the N sets of point group information stored in the storage unit 12 in the past (where N is a positive integer equal to or larger than 2, e.g., N=2 (indicating two point groups, a previous point group and a current point group)), identifies points corresponding to each other between the point groups, and determines the displacement between the corresponding points (represented in the coordinate system of the virtual space, for example, a Cartesian coordinate system (ξ, η, ζ)). The controller 11 then determines, for each label, the statistical value (for example, the average or the median) of the displacement of each point to which the label is added.

The statistical value of the displacement is equivalent to the displacement of the bone corresponding to the label (time variation information on the time variation in the position and the direction of each bone). Thus, the controller 11 estimates the displacement of each bone on the basis of the statistical value. The controller 11 estimates, for example, the displacement of the bones corresponding to the distal portions of the bone model (the lower arms and the lower limbs) on the basis of point groups (the displacement of points having labels corresponding to the left and right lower arms and the left and right lower limbs), as described above. The controller 11 then may estimate the displacement of each bone using a method of inverse kinematics (IKs) in which the displacement of the upper arms or upper limbs respectively connected to the lower arms or the lower limbs is estimated through inverse kinematics, then, similarly, the displacement of the trunk connected with the upper arms or the upper limbs is estimated on the basis of the movement of the upper arms or the upper limbs, and so on.

The controller 11 may use, in combination, the estimation based on the point groups (the displacement of each point is Δξpc_i, Δηpc_i, Δζpc_i (where i is i=1, 2, . . . which conveniently represents identifiers unique to the respective points labeled with a common label)) and the result of estimation of the displacement (which is ΔξIK, ΔηIK, ΔζIK) of the point closest to the i-th point on a bone through inverse kinematics, to estimate the displacement of each point.

For example, in an example of the present embodiment, the controller 11 determines the distance r between a bone and a point (a virtual volume element) to be the distance between the rotary axis of a cylinder and the point, the cylinder approximating a range of the virtual space in which a labeled point group resides, the label indicating that the point group corresponds to the bone.

The controller 11 of this example then uses the information on the distance r to determine a parameter a that monotonically increases in proportion to r such that the parameter α approaches “1” as the r increases, and the parameter α equals “0” when r=0. The controller 11 may use the parameter α and determine the displacement of the i-th point (Δξpc_i, Δηpc_i, Δζpc_i) to be

Δξ_i=(1−α)·ΔξIK+α·Δξpc_i,
Δn_i=(1−α)·ΔηIK+α·Δηpc_i, and
Δζ_i=(1−α)·ΔIK+α·Δζpc_i.
According to this example, a point close to a bone is estimated to have shifted by the displacement determined by the estimation based on the bone, and a point remote from the bone reflects the displacement estimated for the point group. Thus, for example, the movement of a sleeve covering an upper arm, which is relatively remote from the bone, reflects the actual movement, and, at the same time, the sleeve is prevented from undergoing an unnatural movement of shifting to a location significantly different from the result of the estimated displacement of the bone.

Note that the parameter α may be different values for different sites. For example, for the head, the distance r may be used to determine a parameter α that monotonically increases relative to r such that the parameter α approaches “1” as the r increases, and the parameter α equals “0” when r=0, where the distance r is the distance from the center of the bone (the center of the bone is the center of a rotary axis in the longitudinal direction of a cylinder approximating a range of the virtual space in which a labeled point group resides, the label indicating that the point group corresponds to the bone, that is, the center of the bone is the center of the cylinder). This prevents a point group that is presumably hair residing in the vicinity of the bone on the cranial side from rigidly shifting together with the bone.

The controller 11 uses the displacement estimated in this way for each point in the point group to generate point group information on the point group in which points placed at positions in the virtual space after a predetermined time duration. In this way, the controller 11 estimates information on the positions and the orientations of the bones after a predetermined time duration based on the time variation information regarding positions and orientations of the detected bones, and then based on the estimated positions of the respective bones, estimates destination positions of the virtual volume elements identified as virtual volume elements that shift together with the respective bones.

The controller 11 generates virtual space information including the point group, renders the point group in the field of view of a virtual camera placed at a predetermined position (such as at the position of the eyes of the user) in the virtual space, to generate image data, output the generated image data to the display 2 of the user, and present the image data to the user.

### <When Bone can be Detected>

When the controller 11 can estimate the positions and angles of the bones and joints of a target object on the basis of imaging data captured by the imaging unit 14, and the like (without using point group information), the displacement of the respective bones (the time variation information regarding the positions and the orientations of the respective bones) may be estimated on the basis of the estimated positions and angles, without referring to the displacement of the point group (note that, since estimation methods of bones and joints based on image are well known, detailed descriptions will be omitted here). In such a case, when the displacement of the bones cannot be estimated on the basis of image data, the displacement of the bones may be estimated on the basis of the displacement of the point group labeled by the controller 11.

### <Estimation Using Database>

In the above, the result of the estimated position and angle of a bone after a predetermined time duration based on the displacement of the bone (the time variation in the position and angle) is acquired by multiplying the displacement of the bone per unit time by the predetermined time duration. However, the present embodiment is not limited thereto. For such a variation in the displacement of the bone, the variation of typical poses (which have been actually measured in the past) may be machine-learned and recorded in a database so that the result of the estimation of the position and angle of the bone after a predetermined time can be retrieved by inputting the displacement of the bone.

The database may be stored in the storage unit 12 or may be stored in an external server computer that is accessible via the communication unit 15.

### <Correction>

In this example, a point close to a bone is estimated to have moved by a distance corresponding to the displacement in accordance with the result of estimation based on the bone, and a point remote from the bone reflects the displacement estimated for the point group. However, the present embodiment is not limited thereto. For example, for a point remote from the bone toward the lower side in the gravity direction by a distance larger than a predetermined value, the estimated displacement for the point group may be reflected even more intensely. That is, for a point residing at a position remote from the bone by a predetermined distance or larger on the lower side in the gravity direction, the parameter α is set to a value closer to “1” (a value that more intensely reflects the estimated displacement for the point group) than for a point not remote.

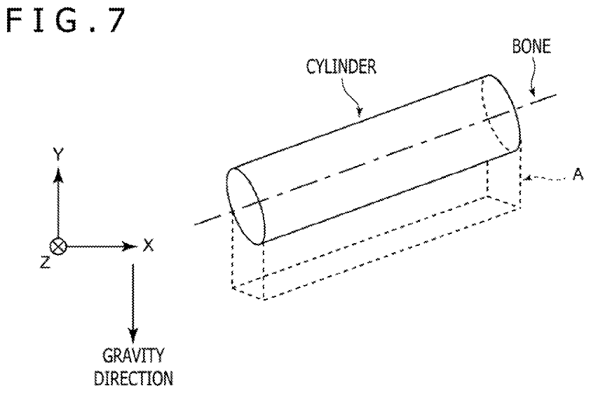

As illustrated in FIG. 7, this correction is based on the following presumption: points in the vicinity of a bone shift together with, for example, an arm of the human body; whereas points remote from the bone by a predetermined distance or larger (a distance equivalent to the dimensions of a portion, such as the thickness of an arm) and provided with a label corresponding to the site (points that may reside in region A in FIG. 7) follow the shift of the site of the human body but move independently from the movement of the site (i.e., can move like a soft body), such as in clothes; and the points farther from the bone in the gravity direction on the lower side move more independently from the movement of the site because the movement is affected by gravity and external forces, such as wind.

### <Example of Setting Position of Point Group Relative to Bone>

In the description above, the position of each virtual volume element at a predetermined timing is estimated on the basis of the displacement of each virtual volume element in the past, such as each point in a point group, while using the information on a bone. However, the present embodiment is not limited thereto.

In an example of the present embodiment, after estimating the position and orientation of a bone at a predetermined timing, the points included in a point group provided with a label corresponding to the bone having the estimated position and orientation may be dispersed within a cylinder circumscribing the bone at a predetermined density, in place of using past displacements of the respective virtual volume elements. A method such as non-linear optimization may be used as the method of determining such positions. In such a case, the virtual volume elements may be dispersedly positioned such that the bone is included on the relatively upper side in the gravity direction. The color of each virtual volume element can be determined through a procedure of referring to a past virtual volume element residing at a position closest to the position of the current virtual volume element whose color is to be determined, and determining the color of this past virtual volume element to be the color of the current virtual volume element.

### <Past Images and Slow Motion>

The controller 11 of the information processor 1 may refer to the information saved in the past on the positions and colors of the virtual volume elements in a virtual space (virtual space information), detect, for at least a portion of the virtual volume elements, time variation information on the virtual space information representing shift of the virtual volume elements in the past, and estimate the positions and colors of the respective virtual volume element at a timing in the past. In specific, the controller 11 saves, in the storage unit 12, the information on the colors and positions of the virtual volume elements (such as a point group) in a virtual space representing a target object in a real space determined on the basis of image data captured by the imaging unit 14 at the past timings T0, T1, T2, T3 . . . and the information on the distance to the target object in the real space captured in the pixels of the image data.

The controller 11 determines, at a subsequent timing Tnow (T0<T1<T2<T3 . . . <Tnow), the information on the positions and colors of the respective virtual volume elements that should have be placed in the virtual space at the past timings τ1, τ2, τ3 . . . (τ1<τ2<τ3< . . . <Tnow) (where T0<T1≤τ1, and Δτ=τi+1−τi (i=1, 2, 3 . . . ) is the timing of a constant frame rate), on the basis of the saved information. For example, the controller 11 may determine the information on the positions and colors of the respective virtual volume elements that should have been placed in the virtual space at time T1 on the basis of the information of times before time τ1, among the saved information. In such a case, an extrapolation process is used that is the same as that used in the example of estimating information at a predetermined future time described above.

However, since, in the example of the present embodiment, the information subsequent to the time of estimation is obtained, the information on the positions and colors of the virtual volume elements at the estimation timings τ1, τ2, τ3 . . . may be determined through an interpolation process. That is, the controller 11 acquires information at time τ1 on the positions and colors of the respective virtual volume elements that should have been placed in the virtual space at the time τ1 by interpolating the information before time τ1 (information at time T0 and T1) and the information subsequent to the time τ1 (information at time T2, T3 . . . ). Since a well-known process may be used for the interpolation, a detailed description of the process will be omitted.

In this example, since the position of the point group in the virtual space at the past times τ1, τ2, τ3 . . . are estimated, the controller 11 renders the image (the point group, etc.) of the virtual space obtained as a result of the estimation in the field of view of a virtual camera placed at a predetermined position (such as at the position of the eyes of the user) in the virtual space, to generate image data and output the generated image data to the display 2 of the user via the communication unit 15. At this time, the images of the virtual space at the past times τ1, τ2, τ3 . . . can be output as images captured at the constant timings of Δτ=τi+1−τi, to repeat the past images.

Note that, here, the timing of the frame rate is Δτ=τi+1−τi. Alternatively, in the present embodiment, the controller 11 may set Δτ=τi+1−τi to be an integral multiple of the frame rate. In specific, Δτ may be 1/120 when the frame rate is 30 fps. The controller 11 then outputs images of the virtual space at the past times τ1, τ2, τ3 . . . in accordance with the frame rate. In this example, a past video image is generated and provided as a slow-motion video image having a rate that is an integral multiple. One characteristic feature of the present embodiment is that an image at a predetermined time is not information acquired at the predetermined time but acquired by estimating the image on the basis of information acquired before, or before and after the predetermined time.

### <Simulation Engine>

In the example described above, the controller 11 estimates the positions and colors of the respective virtual volume elements at a predetermined future timing or a past timing through extrapolation based on the time variation information on the positions and colors of the virtual volume elements placed in the virtual space. However, the present embodiment is not limited thereto, and alternatively, the controller 11 may perform a simulation on the basis of the positions and colors of the virtual volume elements placed in a virtual space, using a predetermined simulation engine, and determine the result of the simulation to be the estimated positions and colors of the respective virtual volume elements at a predetermined future timing or a past timing. The simulation may be performed through various simulation processes, such as a simulation based on a physical phenomenon (so-called physical simulation), a simulation having an animation effect exaggerating a physical phenomenon (a simulation to which an animation process is applied to exaggerate deformation and produce an effect that causes particles to disperse when touched), and a simulation of a chemical phenomenon (response simulation).

In this example, information on, for example, a variation in the shift direction and shape (such as elastic deformation of a ball or the like) due to interaction (for example, collision between objects) between target objects placed in a virtual space and a variation in the shift rate due to the influence of gravity is reflected, allowing a more natural estimation. In such a case, a simulation of particle motion may be performed in which the respective virtual volume elements are presumed to be rigid particles.

<Example in which Portion of Processing is Performed Via Network>

In the description above, the controller 11 of the information processor 1 carries out the operation of the real-space information acquirer 31, the point-group allocator 32, the saver 33, the estimator 34, the estimated-point-group allocator 35, and the virtual-space information generator 36. Alternative to this example, the controller 11 may send image data captured by the imaging unit 14 and information acquired on the distance to a target object in a real space to a separate server; instruct the server to carry out the operation of at least one of the real-space information acquirer 31, the point-group allocator 32, the saver 33, the estimator 34, the estimated-point-group allocator 35, the virtual-space information generator 36, and the output unit 37; instruct the server send out the result of processing image data, etc., acquired by rendering a point group in a field of view of a virtual camera placed at a predetermined position (for example, at the position of the eyes of the user) in the virtual space, to the information processor 1 or the display 2 of the user; and perform the subsequent process at the information processor 1 or the display 2.

For example, when the process up to the output unit 37 is carried out at the server, the server operating as the output unit 37 sends out image data to the display 2 of the user via communication means (such as a network interface) of the server, without using the information processor 1.

In this example, the server operating as the real-space information acquirer 31 receives image data captured by the imaging unit 14 of the information processor 1 and information on the distance to the target object in the real space captured as pixels in the image data.

In such a case, information may be transmitted and received between the information processor 1 and the server via communication paths, such as the Internet and a mobile phone line. In other words, the server according to this example may be accessible via the Internet.

In another example of the present embodiment, the server may carry out the processes of the point-group allocator 32, the saver 33, and the estimator 34, and send out the result of estimation of the positions of the points in a point group to the information processor 1 of the user, which is the provider of image data to be processed and information on the exterior appearance. In such a case, the downstream processes including the estimated-point-group allocator 35, the virtual-space information generator 36, and the output unit 37 are carried out at the information processor 1 of the user. Similarly, the processes up to the estimated-point-group allocator 35 or the virtual-space information generator 36 may be carried out at the server, and the subsequent processes may be carried out at the information processor 1 of the user.

The description of the present embodiment is merely an example, and various modifications can be made without departing from the scope of the present invention. For example, the process described above in the example of a point group may similarly be applied to, for example, other virtual volume elements and voxels.

### REFERENCE SIGNS LIST

1 Information processor, 2 Display, 11 Controller, 12 Storage unit, 13 Operation receiver, 14 Imaging unit, 15 Communication unit, 21 Controller, 22 Communication unit, 23 Display unit, 31 Real-space information acquirer, 32 Point-group allocator, 33 Saver, 34 Estimator, 35 Estimated-point-group allocator, 36 Virtual-space information generator, 37 Output unit.

1. An information processor comprising:
an acquirer that acquires information regarding a position and exterior appearance of a target object in a real space;
a virtual-space information generator that places multiple virtual volume elements in a virtual space at positions corresponding to at least along the exterior appearance of the target object in the real space determined by the acquirer and generates virtual space information representing the target object as a cluster of the virtual volume elements;
a storer that stores the generated virtual space information;
a detector that refers to the stored information and detects time variation information of the virtual space information representing shift of at least a portion of the virtual volume elements; and
an estimator that performs estimation of positions of the virtual volume elements after a predetermined time duration based on the detected time variation information,
the virtual-space information generator generating and outputting virtual space information after a predetermined time duration based on a result of the estimation.

2. The information processor according to claim 1, wherein,
when shift or change in orientation of the target object is to be estimated based on a preliminarily established bone model, the detector identifies the virtual volume elements that shift together with bones included in the bone model and detects, as time variation information on a time variation in the virtual space information, time variation information regarding positions and orientations of the respective bones of the bone model, and
the estimator estimates information regarding positions and orientations of the respective bones after a predetermined time duration based on the detected time variation information regarding positions and orientations of the respective bones, and, based on the estimated positions of the respective bones, estimates destination positions of the virtual volume elements identified as virtual volume elements that shift together with the respective bones.

3. The information processor according to claim 2, wherein
the information processor is connected with and accessible to a database storing the time variation information regarding positions and orientations of the respective bones in correlation with information on actual destination positions of the bones measured in the past after the time variation information is acquired, and
the estimator estimates, based on the information stored in the database, positions and orientations of the respective bones after a predetermined time duration, based on the detected time variation information regarding positions and orientations of the respective bones.

4. The information processor according to claim 1, wherein the predetermined time duration is the duration of time until a subsequent predetermined drawing timing.

5. The information processor according to claim 1, wherein the information processor refers to the virtual space information stored in the past, detects time variation information on a time variation in the virtual space information representing shift of at least a portion of the virtual volume elements in the past, performs estimation of positions of the virtual volume elements at a predetermined timing in the past based on the detected time variation information, and generates and outputs virtual space information on the virtual space after a predetermined time duration based on the result of estimation.

6. The information processor according to claim 1, wherein the estimator further estimates orientations or shapes of the respective virtual volume elements after a predetermined time duration using a preliminarily established physical simulation engine.

7. A control method of an information processor that uses a computer, comprising:
by an acquirer, acquiring information regarding a position and exterior appearance of a target object in a real space;
by a virtual-space information generator, placing multiple virtual volume elements in a virtual space at positions corresponding to at least along the exterior appearance of the target object in the real space determined by the acquirer and generating virtual space information representing the target object as a cluster of the virtual volume elements;
by a storer, storing the generated virtual space information;
by a detector, detecting time variation information of the virtual space information representing shift of at least a portion of the virtual volume elements; and
by an estimator, performing estimation of positions of the virtual volume elements after a predetermined time duration based on the detected time variation information, wherein
the virtual-space information generator generates and outputs virtual space information after a predetermined time duration based on a result of the estimation.

8. A program for a computer comprising:
an acquirer that acquires information regarding a position and exterior appearance of a target object in a real space;
a virtual-space information generator that places multiple virtual volume elements in a virtual space at positions corresponding to at least along the exterior appearance of the target object in the real space determined by the acquirer and generates virtual space information representing the target object as a cluster of the virtual volume elements;
a storer that stores the generated virtual space information;
a detector that detects time variation information of the virtual space information representing shift of at least a portion of the virtual volume elements; and
an estimator that estimates positions of the virtual volume elements after a predetermined time duration based on the detected time variation information, wherein the virtual-space information generator generates and outputs virtual space information after a predetermined time duration based on a result of the estimation.
